(19) United States
(12) Patent Application Publication
(10) Pub. No.: US 2018/0307071 A1
(43) Pub. Date: Oct. 25, 2018

(54) LIQUID CRYSTAL DISPLAY PANEL, MANUFACTURING METHOD THEREOF, AND DISPLAY DEVICE APPLIED THERETO

(71) Applicants: HKC CORPORATION LIMITED, Shenzhen (CN); CHONGQING HKC OPTOELECTRONICS TECHNOLOGY CORPORATION LIMITED, Chongqing (CN)

(72) Inventor: Yu-Jen CHEN, Chongqing (CN)

(73) Assignees: HKC CORPORATION LIMITED, Shenzhen (CN); CHONGQING HKC OPTOELECTRONICS TECHNOLOGY CORPORATION LIMITED, Chongqing (CN)

(21) Appl. No.: 15/553,987

(22) PCT Filed: Apr. 28, 2017
(86) PCT No.: PCT/CN2017/082362

§ 371 Date: Aug. 26, 2017

(30) Foreign Application Priority Data
Apr. 24, 2017 (CN) 201710272094.1

(51) Int. Cl. G02F 1/1339; G02F 1/1335; G02F 1/1343

(52) U.S. Cl. CPC G02F 1/1339; G02F 1/133512; G02F 2201/121; G02F 1/1343; G02F 1/133514

(57) ABSTRACT

The present application discloses a liquid crystal display panel, its manufacturing method, and a display device applied thereto. The liquid crystal display panel comprises a first substrate and a second substrate, wherein a common electrode is provided on an inside of the first substrate; a black matrix and a photo spacer are made of the same material, and is integrally formed on the common electrode; a transfer pad is provided on the inside of the second substrate, and the integrally formed structure that is corresponding to the transfer pad has a hollowed-out structure. A metal structure that serves as an electrode connection point is provided on the inside of the second substrate to connect to the transfer pad. A layout shape of the metal structure and a layout shape of the integrally formed structure that is at the border frame region portion are of complementary relation.

### TECHNICAL FIELD

The present application relates to the technical field of liquid crystal displays, and applies the improvement mode of the common electrode of liquid crystal display panels that is designed by using the Color on Array process. The present application particularly relates to the application of the integrally formed structure of a black matrix and a photo spacer to the Color on Array process, and particularly relates to a liquid crystal display panel, manufacturing method thereof, and a display device applying the same.

### BACKGROUND ART

Thin film transistor-liquid crystal displays (TFT-LCD) are formed by a first substrate (that is, a color filters substrate (CF)), a second substrate (that is, a transistor array substrate (TFT)), and liquid crystal (LC) and sealant that are sandwiched between the color filters substrate and the transistor array substrate.

Thin film transistor-liquid crystal displays have two display modes: In Plane Switch (IPS) and Vertical Alignment (VA). The In Plane Switch mode refers to the horizontal alignment of liquid crystal, wherein in operation the liquid crystal molecules rotate parallelly to conduct displaying and imaging. The Vertical Alignment mode refers to the vertical alignment of liquid crystal, wherein when no voltage is applied the liquid crystal molecules are perpendicular to the two substrates of the screen, and when a voltage is applied the liquid crystal molecules incline to form a certain angle with the substrate.

At present, the Color on Array (COA) technique, due to the advantages of high penetration and low cost, has become the mainstream of the technique development of manufacturers. On the basis of the Color on Array design, in order to save the process cost, some manufacturers are developing integrally formed materials of black matrix (BM) and photo spacer (PS). However, such a type of materials have low optical concentration values, and need the effect of stacked color filters at local positions to facilitate light shading.

However, when the integrally formed structures are applied to products of liquid crystal display panels of vertical alignment mode that employ the Color on Array technique, some problems must be overcome. Generally, the signals of the common electrodes of the liquid crystal cells of vertical alignment mode require a transfer pad to transmit them from a second substrate to the common electrode of a first substrate. However, when the integrally formed structure is applied, the common electrode is required to be fabricated before the integrally formed structure, so the transfer pad has the risking of incomplete sealant solidification, and that results in that the common electrodes of the first substrate and the second substrate cannot be fed-through by indium tin oxide.

### SUMMARY OF THE INVENTION

The technical problem that the present application seeks to solve is: to provide a liquid crystal display panel, its manufacturing method, and a display device applying it, which are applied to products of liquid crystal display panels of vertical alignment mode that employ the Color on Array technique, to overcome the defects that the common electrodes of the first substrate and the second substrate cannot be fed-through by indium tin oxide and that the solidification of the sealant at the transfer pad is not complete.

In order to solve the above technical problem, the technical solution that is employed by the present application is: a liquid crystal display panel, comprising a first substrate and a second substrate, wherein, a common electrode is provided on an inside of the first substrate, a black matrix and a photo spacer are made of the same material and are integrally formed on the common electrode by the same process to form an integrally formed structure, a transfer pad is provided on the inside of the second substrate, and the integrally formed structure that is located on the first substrate and corresponds to the transfer pad has a hollowed-out structure.

In an embodiment of the present application, the ratio of the transparent area to the shading area of the integrally formed structure that is corresponding to the transfer pad is between 0.5-1.5.

In an embodiment of the present application, a metal structure that serves as an electrode connection point is provided at the border frame region portion that is on the inside of the second substrate to connect to the transfer pad over it.

In an embodiment of the present application, the metal structure has a hollowed-out structure, a layout shape of the metal structure and a layout shape of the integrally formed structure that is at the border frame region portion are of complementary relation, and the metal structure is provided with blue color filters, red color filters or blue color filters and red color filters that are stacked.

The present application further provides a liquid crystal display device, comprising a backlight module and a display panel, wherein, the display panel comprises: a first substrate; a second substrate; a black matrix, comprising a solid portion and a hollowed-out portion adjacent to the solid portion that are parallelly provided on the first substrate and have a spacing therebetween; a photo spacer, provided on the first substrate; wherein, spacings of the hollowed-out portion of the black matrix are equidistant or inequidistant, and a ratio of a transparent area to a shading area of the black matrix is between 0.5-1.5; a common electrode, sandwiched between the first substrate and the black matrix, wherein the hollowed-out area of the black matrix exposes the common electrode; and a transfer pad, provided on the second substrate, wherein the transfer pad comprises: a metal structure, comprising a solid portion and a hollowed-out portion adjacent to the solid portion that are parallelly provided on the second substrate and have a spacing therebetween; wherein, spacings of the hollowed-out portion of the metal structure are equidistant or inequidistant, a ratio of a transparent area to a shading area of the metal structure is between 0.5-1.5; preferably, the solid portion of the metal structure covers the hollowed-out portion of the black matrix, and the solid portion of the black matrix covers the hollowed-out portion of the metal structure; color filters, comprising a solid portion and a hollowed-out portion adjacent to the solid portion that are parallelly provided on the metal structure and that are covered by the metal structure; wherein, spacings of the hollowed-out portion of the color filters are equidistant or inequidistant, the color filters are red color filters, blue color filters, or red color filters and blue color filters that are stacked, and a ratio of a transparent area to a shading area of the color filters is between 0.5-1.5; another common electrode, provided on the second substrate, and covering the solid portion and the hollowed-out portion of the color filters and the solid portion and the hollowed-out portion of the metal structure; a sealant, provided between the first substrate and the second substrate, and filling the hollowed-out portion of the color filters, the hollowed-out portion of the metal structure and the hollowed-out portion of the black matrix; and an electrically conducting gold ball, sandwiched between the first substrate and the second substrate, wherein the electrically conducting gold ball is located on the solid portion of the color filters, and is embedded into the hollowed-out portion of the black matrix.

In order to solve the above technical problem, another technical solution that is employed by the present application is: a method for manufacturing a liquid crystal display panel, comprising the steps of:

providing a first substrate and a second substrate;

forming a liquid crystal layer between the first substrate and the second substrate; and

laying a common electrode on an inside of the first substrate;

wherein a black matrix and a photo spacer are made of the same material, and are integrally formed on the first substrate by the same process; wherein, the integrally formed structure is located under the common electrode.

In an embodiment of the present application, the integrally formed structure that is corresponding to the transfer pad is a hollowed-out structure. Further, the ratio of the transparent area to the shading area of the integrally formed structure that is corresponding to the transfer pad is between 0.5-1.5.

In an embodiment of the present application, the method for manufacturing a liquid crystal display panel further comprises the steps of:

providing a metal structure that serves as an electrode connection point at the border frame region portion that is on an inside of the second substrate to connect to the transfer pad; and

providing on the metal structure blue color filters, red color filters, or blue color filters and red color filters that are stacked.

In an embodiment of the present application, the metal structure has a hollowed-out structure, and a layout shape of the metal structure and a layout shape of the integrally formed structure that is at the border frame region portion are of complementary relation.

Making the black matrix and the photo spacer by using the same material can simplify the color filters process flow, but when it is applied to liquid crystal display panels of vertical alignment and used at the common electrode connection points in the process of liquid crystal panel section, changes in the structure are required, by providing on the metal of the second substrate blue color filters, red color filters, or blue color filters and red color filters that are stacked, to compensate for the possibility of the light leakage that is caused by the hollowed-out portion of the integrally formed structure, and increase the optical concentration value.

The present application, in terms of process flow, does not add the cost of the liquid crystal panel process, and can effectively prevent the risk of light leakage of the back edge of the module.

### BRIEF DESCRIPTION OF THE DRAWINGS

FIG. 1 is the schematic diagram of the structure of the liquid crystal display panel of the present application.

FIG. 2 is the schematic diagram of the structure of the border frame region of the liquid crystal display panel of the present application.

FIG. 3a is the schematic diagram of the shape of the hollowed-out structure of the electrode connection point metal sheet of the second substrate.

FIG. 3b is the schematic diagram of the hollowed-out shape of the integrally formed structure of the first substrate that is at the border frame region portion.

FIG. 3c is the schematic diagram of the combination of the second substrate and the first substrate.

FIG. 4 is the schematic diagram of the effect of the liquid crystal display panel that comprises a backlight module of the present application.

FIG. 5 is the schematic diagrams of the six embodiments of the hollowed-out shape of the integrally formed structure of the first substrate that is at the border frame region portion.

FIG. 6a is the process flow chart of the integrally formed structure of the first substrate.

FIG. 6b is the process flow chart of the transfer pad of the second substrate.

### DETAILED DESCRIPTION OF THE INVENTION

The descriptions of the following embodiments are intended to by referring to the attached drawings illustrate the special embodiments that can be implemented by the present application. The wordings regarding directions that are mentioned in the present application, such as “upper”, “lower”, “front”, “back”, “left”, “right”, “inner”, “outer”, and “side”, are merely by referring to the directions of the attached drawings. Therefore, the employed wordings regarding directions are intended to illustrate and understand the present application, and not to limit the present application.

The drawings and the description are considered as illustrative in natural, rather than restrictive. In the drawings, elements of the similar structures are indicated by the same reference numbers. Additionally, in order to facilitate the understanding and the describing, the sizes and the thicknesses of the components shown in the drawings are drawn randomly, but the present application is not limited thereto.

In the drawings, for the sake of clarity, the thicknesses of the layers, the films, the panels and the areas are exaggerated. In the drawings, in order to facilitate the understanding and the describing, the thicknesses of some layers and areas are exaggerated. It is understood that, when a component of, for example, the layers, the films, the areas or the substrate is described as “on” another component, the component may be directly on the another component, or there may be an intermediate component.

Additionally, in the description, unless explicitly described otherwise, the word “comprise” will be understood as meaning comprising the component, but not excluding any other component. Furthermore, in the description, “on” means being located above or below the target component, and does not mean that it must be located on the top in the gravity direction.

In order to further illustrate the technical means that are employed by the present application to achieve the predetermined object and the effects, the special embodiments, structures, characteristics and effects of the liquid crystal display panel, its manufacturing method, and display device applying it that are provided by the present application are in detailed described below by referring to the drawings and the preferred embodiments.

In an embodiment of the present application, the color filters comprise a main body part and an extension part. The color filters that are located at the displaying region are used for exhibiting multiple colors, and the color filters that are located at the border frame region comprises a solid portion and a hollowed-out portion adjacent to the solid portion. Spacings of the hollowed-out portion of the color filters are equidistant or inequidistant, whose ratio of a transparent area to a shading area is between 0.5-1.5, to compensate for the possibility of the light leakage that is caused by the hollowed-out portion of the integrally formed structure, and to increase the optical concentration value.

In an embodiment of the present application, the black matrix and the photo spacer located on the first substrate are made of the same material, and are integrally formed on the first substrate by the same process, so as to complete an integrally formed structure. In that, the black matrix layer comprises a solid portion and a hollowed-out portion adjacent to the solid portion, and spacings of the hollowed-out portion of the black matrix are equidistant or inequidistant, whose ratio of a transparent area to a shading area is between 0.5-1.5.

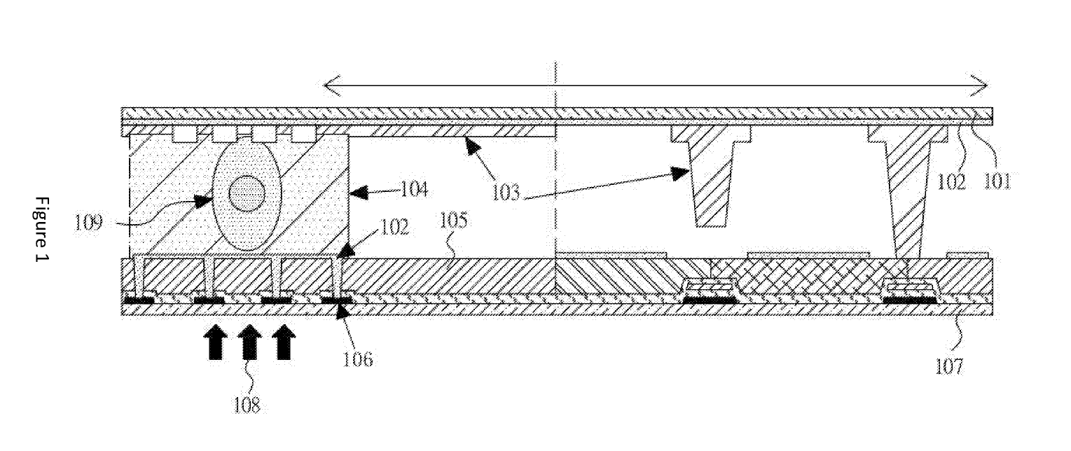

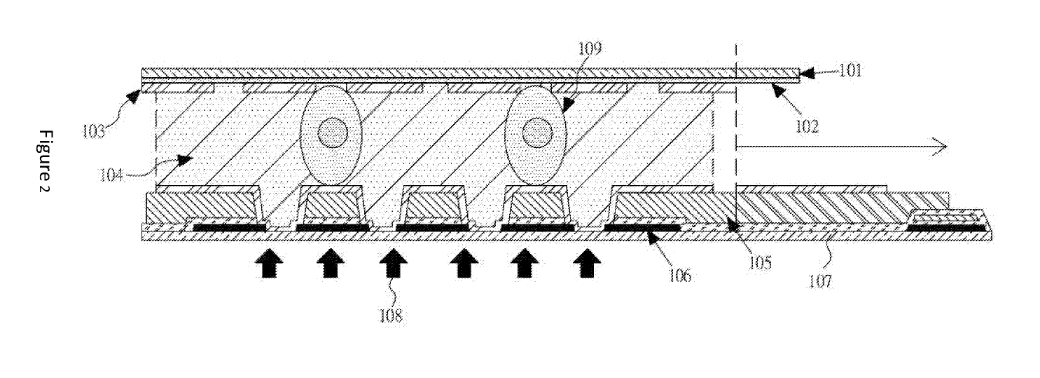

FIG. 1 shows the schematic diagram of the liquid crystal display panel of the present application, and FIG. 2 shows the schematic diagram of the particular structure of the border frame region of the liquid crystal display panel of the present application. Simultaneously referring to FIG. 1 and FIG. 2, a liquid crystal display panel comprises: a first substrate 101 and a second substrate 107. A common electrode 102 is provided on the inside of the first substrate 101, and the common electrode 102 is sandwiched between the first substrate 101 and the black matrix. An integrally formed structure 103 is integrally formed on the common electrode 102 by the same process by using the black matrix and a photo spacer that are made of the same material. The hollowed-out portion of the black matrix exposes the common electrode 102. The integrally formed structure 103 has an open design at the border frame region portion and has a hollowed-out structure, whose ratio of a transparent area to a shading area is between 0.5-1.5, and the common electrode 102 is provided on the inside of the second substrate 107.

In an embodiment, the liquid crystal display panel of the present application may be a curve-face liquid crystal display panel.

A metal structure 106 that serves as an electrode connection point is provided at the border frame region portion that is on the inside of the second substrate 107 to connect to the transfer pad, and the metal structure 106 has an open design and has a hollowed-out portion. The metal structure 106 comprises a solid portion and a hollowed-out portion adjacent to the solid portion, the hollowed-out portion of the metal structure 106 are equidistant or inequidistant, and the layout shape of the metal structure 106 and the layout shape of the integrally formed structure 103 that is at the border frame region portion are of complementary relation. Preferably, the solid portion of the metal structure 106 covers the hollowed-out portion of the black matrix 103, and the solid portion of the black matrix 103 covers the hollowed-out portion of the metal structure 106. The metal structure 106 is provided with color filters 105, which may be blue color filters, red color filters or blue color filters and red color filters that are stacked. The color filters 105 are covered by the metal structure 106. The purpose of providing the color filters 105 are to avoid the possibility of the light leakage that is caused by the open design of the border frame region portion of the integrally formed structure 103 located on the first substrate 101, and the stacking of the color filters 105 at the transfer pad of the second substrate compensates for the range of light leakage and increases the optical concentration value. In that, the common electrode 102 and the color filters 105, which are located at the border frame region of the second substrate, and the metal structure 106 are a transfer pad, and the common electrode 102 covers the solid portion and the hollowed-out portion of the color filters 105 and the solid portion and the hollowed-out portion of the metal structure 106. An electrically conducting gold ball 109 is located over the color filters of the second substrate, and located under the hollowed-out portion of the integrally formed structure of the first substrate. Preferably, the electrically conducting gold ball 109 is located on the solid portion of the color filters 105, and is embedded into the hollowed-out portion of the black matrix 103. Furthermore, an ultraviolet ray 108 is selected to irradiate on the side of a transistor array substrate 107, to solidify a sealant 104, wherein the sealant 104 fills the hollowed-out structure of the color filters 105, the hollowed-out portion of the metal structure 106 and the hollowed-out portion of the black matrix 103.

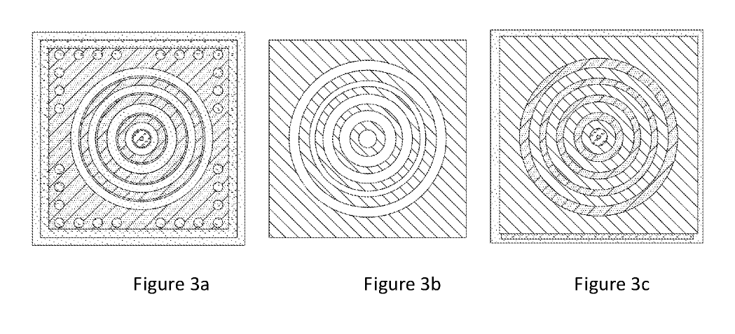

FIG. 3a shows an embodiment of the shape of the hollowed-out portion of the metal structure of the second substrate.

FIG. 3b shows an embodiment of the hollowed-out shape at the border frame region portion of the integrally formed structure of the first substrate.

FIG. 3c shows the schematic diagram of the combination of the second substrate of FIG. 3a and the first substrate of FIG. 3b. Simultaneously referring to FIG. 3a and FIG. 3b, in an embodiment of the present application, the integrally formed structure of the first substrate and the metal portion of the second substrate are complementarily combined at the border frame region portion, which compensates for the possibility of the light leakage that is caused by the open design of the border frame region portion of the integrally formed structure, and increases the optical concentration value.

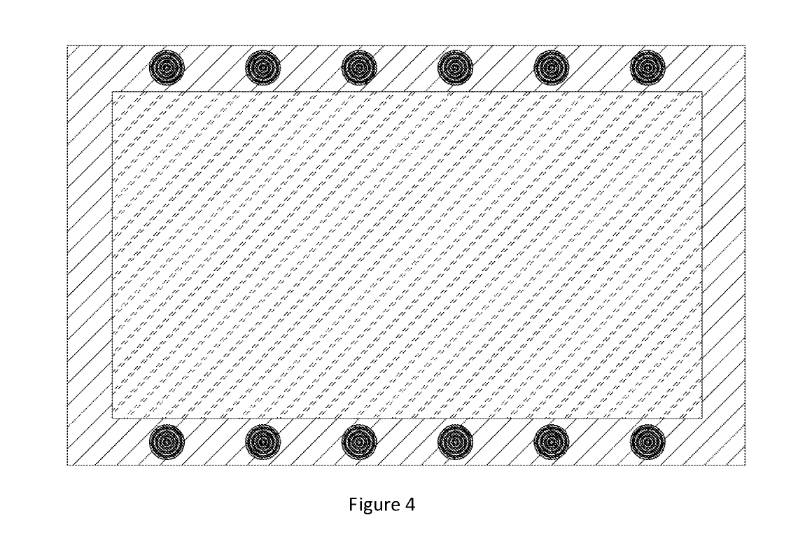

FIG. 4 shows the schematic diagram of the effect of the liquid crystal display panel that comprises a backlight module of the present application. The border frame region portion around the liquid crystal display panel employs the integrally formed structure of the present application, and a layout shape of the metal structure and a layout shape of the integrally formed structure that is at the border frame region portion are of complementary relation, which on the one hand technically saves process steps and decreases the cost, and on the other hand compensates for the possibility of the light leakage that is caused by the hollowed-out portion of the border frame region portion of the integrally formed structure.

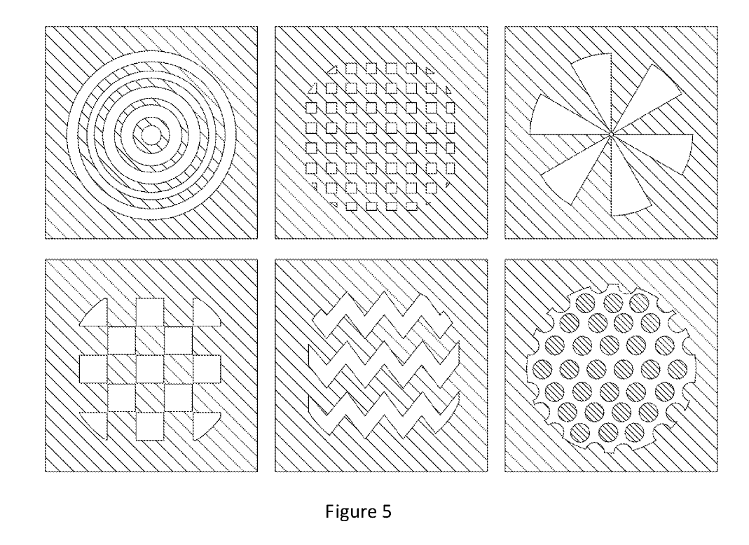

FIG. 5 is six schematic diagrams of the hollowed-out shape at the border frame region portion of the integrally formed structure of an embodiment of the present application. The integrally formed structure comprises, besides a central annular structure, the following embodiments:

In an embodiment of the present application, the integrally formed structure is a net structure.

In an embodiment of the present application, the integrally formed structure is a sector structure.

In an embodiment of the present application, the integrally formed structure is a staggered chessboard structure.

In an embodiment of the present application, the integrally formed structure is a staggered saw tooth structure.

In an embodiment of the present application, the integrally formed structure is a round net structure.

In an embodiment of the present application, the hollowed-out structure of the integrally formed structure is a regular-shaped light transmission shape, whose ratio of a transparent area to a shading area is between 0.5-1.5, and the form of the hollowed-out portion can be determined according to the demands of the designer, and is not limited.

The present application is a process design that applies the integrally formed structure to RGB or WRGB matrices, and in particular aims at liquid crystal display panels of vertical alignment mode. Because the black matrix and the photo spacer employ the same material and the same process, the common electrode process of the color filters substrate is adjusted from after the black matrix process to before the black matrix process. At the connection points of the common electrode of the external circuit, because the common electrode process of the color filters substrate is adjusted, correspondingly, the corresponding transfer pad on the border frame region of the integrally formed structure is required to be structurally adjusted, by designing the shape of the integrally formed structure that is at the border frame region portion into a locally light-transmitting regular shape. Correspondingly, the layout shape of the metal of the second substrate and the layout shape of the integrally formed structure that is at the border frame region portion are of complementary relation. Additionally, the present application avoids the possibility of light leakage, and the stacking of the color filters at the transfer pad of the second substrate compensates for the range of light leakage.

The present application further provides a liquid crystal display device, comprising a backlight module, and further comprising the liquid crystal display panel of the embodiment of any one of FIG. 1 to FIG. 3.

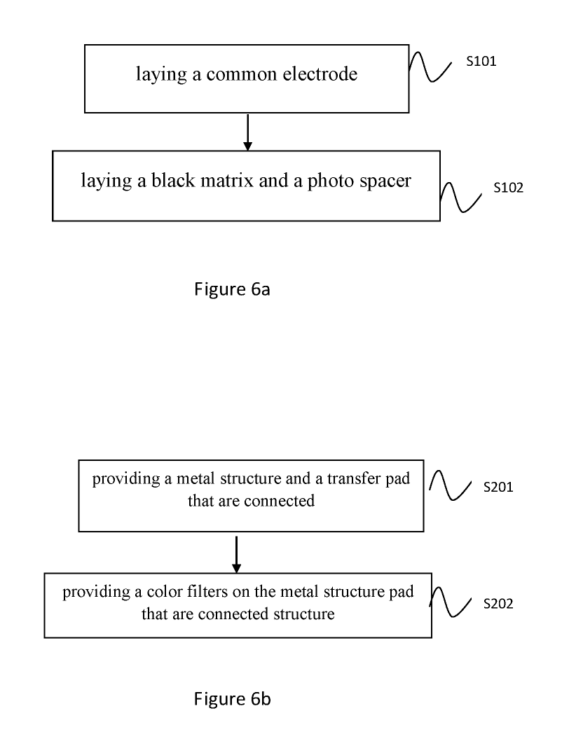

Therefore, the present application provides a method for manufacturing a liquid crystal display panel, comprising the steps of the process flow of the first substrate shown by FIG. 6a:

Step S101: laying a common electrode, by laying a layer of indium tin oxide on the inside of the first substrate to serve as the common electrode; and

Step S102: laying a black matrix and a photo spacer, wherein the black matrix and the photo spacer are made of the same material, and are integrally formed on the first substrate by the same process.

Preferably, the integrally formed structure is a hollowed-out structure at the border frame region portion, whose ratio of a transparent area to a shading area is between 0.5-1.5 and is located under the common electrode.

The present application further comprises the steps of the process flow of the second substrate shown by FIG. 6b:

Step S201: providing a metal structure and a transfer pad that are connected, by providing a metal structure that serves as an electrode connection point on the inside of the second substrate to connect to the transfer pad; and

Step S202: providing color filters on the metal structure, by providing on the metal structure blue color filters, red color filters, or blue color filters and red color filters that are stacked;

Preferably, the metal structure has a hollowed-out structure, a layout shape of the metal structure and a layout shape of the integrally formed structure that is at the border frame region portion are of complementary relation, and a ratio of a transparent area to a shading area of the metal structure is between 0.5-1.5.

The above embodiments are merely preferable embodiments that are presented to fully illustrate the present application, and the protection scope of the present application is not limited thereto. The equivalent substitutions or alternations that are made by a person skilled in the art on the basis of the present application all fall within the protection scope of the present application. The protection scope of the present application is limited by the claims.

What is claimed is:

1. A liquid crystal display panel, comprising:
a first substrate;
a second substrate, disposed oppositely to the first substrate;
a liquid crystal layer, sandwiched between the first substrate and the second substrate; and
a sealant, formed between the first substrate and the second substrate;
wherein, a common electrode is formed on an inside of the first substrate, and a black matrix and photo spacers are made of a same material, and are integrally formed on the first substrate by one single process, so as to obtain an integrally formed structure, and the integrally formed structure is located under the common electrode.

2. The liquid crystal display panel according to claim 1, wherein the integrally formed structure is a hollowed-out structure, and the ratio of a transparent area to a shading area of the hollowed-out structure is between 0.5-1.5.

3. The liquid crystal display panel according to claim 1, wherein a metal structure is formed on an inside of the second substrate, and the metal structure is served as an electrode connection point.

4. The liquid crystal display panel according to claim 3, wherein the metal structure is connected to a transfer pad, and the transfer pad is over the metal structure.

5. The liquid crystal display panel according to claim 3, wherein the metal structure has a hollowed-out structure.

6. The liquid crystal display panel according to claim 3, wherein a layout shape of the metal structure and a layout shape of the integrally formed structure at the border frame region portion are of complementary relation.

7. The liquid crystal display panel according to claim 3, wherein the metal structure is provided with blue color filters or red color filters, or blue color filters and red color filters stacked.

8. The liquid crystal display panel according to claim 3, wherein a ratio of a transparent area to a shading area of the metal structure is between 0.5-1.5.

9. A method for manufacturing a liquid crystal display panel, comprising:
providing a first substrate and a second substrate; and
forming a liquid crystal layer between the first substrate and the second substrate;
wherein, the process flow of the first substrate comprises the steps of:
laying a common electrode on an inside of the first substrate; and
laying a black matrix and a photo spacer on the common electrode;
preferably, the black matrix and the photo spacer are made of the same material, and are integrally formed on the first substrate by the same process.

10. The method for manufacturing a liquid crystal display panel according to claim 9, wherein the integrally formed structure is located under the common electrode, and corresponds to a transfer pad of the second substrate.

11. The method for manufacturing a liquid crystal display panel according to claim 9, wherein the integrally formed structure corresponding to the transfer pad is a hollowed-out structure.

12. The method for manufacturing a liquid crystal display panel according to claim 9, wherein a ratio of a transparent area to a shading area of the integrally formed structure is between 0.5-1.5.

13. The method for manufacturing a liquid crystal display panel according to claim 9, wherein the process flow of the transfer pad of the second substrate comprises the steps of:
providing a metal structure serves as an electrode connection point at the border frame region portion on an inside of the second substrate to connect to the transfer pad; and
providing on the metal structure blue color filters, red color filters, or both blue color filters and red color filters.

14. The method for manufacturing a liquid crystal display panel according to claim 13, wherein the metal structure has a hollowed-out structure.

15. The method for manufacturing a liquid crystal display panel according to claim 13, wherein a layout shape of the metal structure and a layout shape of the integrally formed structure at the border frame region portion are of complementary relation.

16. A liquid crystal display device, comprising a backlight module and a display panel, wherein, the display panel comprises:
a first substrate;
a second substrate;
a black matrix, comprising a solid portion and a hollowed-out portion adjacent to the solid portion, and the black matrix is parallelly formed on the first substrate and have a spacing therebetween;
a photo spacer, formed on the first substrate;
wherein, spacings of the hollowed-out portion of the black matrix are equidistant or inequidistant, and a ratio of a transparent area to a shading area of the black matrix is between 0.5-1.5;
a common electrode, sandwiched between the first substrate and the black matrix, wherein the hollowed-out area of the black matrix exposes the common electrode; and
a transfer pad, formed on the second substrate, comprising:
a metal structure, comprising a solid portion and a hollowed-out portion adjacent to the solid portion, and the metal structure is parallelly formed on the second substrate and have a spacing therebetween;
wherein, spacings of the hollowed-out portion of the metal structure are equidistant or inequidistant, a ratio of a transparent area to a shading area of the metal structure is between 0.5-1.5; preferably, the solid portion of the metal structure covers the hollowed-out portion of the black matrix, and the solid portion of the black matrix covers the hollowed-out portion of the metal structure;
color filters, comprising a solid portion and a hollowed-out portion adjacent to the solid portion, and the color filters are parallelly formed on the metal structure and are covered by the metal structure;
wherein, spacings of the hollowed-out portion of the color filters are equidistant or inequidistant, the color filters are red color filters, blue color filters, or red color filters and blue color filters stacked, and a ratio of a transparent area to a shading area of the color filters is between 0.5-1.5;
another common electrode, formed on the second substrate, and covering the solid portion and the hollowed-out portion of the color filters and the solid portion and the hollowed-out portion of the metal structure;
a sealant, formed between the first substrate and the second substrate, and filling the hollowed-out portion of the color filters, the hollowed-out portion of the metal structure and the hollowed-out portion of the black matrix; and
an electrically conducting gold ball, sandwiched between the first substrate and the second substrate, wherein the electrically conducting gold ball is located on the solid portion of the color filters, and is embedded into the hollowed-out portion of the black matrix.
